(19) United States
(12) Patent Application Publication
(10) Pub. No.: US 2025/0379488 A1
(43) Pub. Date: Dec. 11, 2025

(54) ELECTROMECHANICAL APPARATUS AND TRANSMISSION UNIT WITH THE ELECTROMECHANICAL APPARATUS AND VEHICLE WITH THE TRANSMISSION UNIT

(71) Applicant: CHE-MOTOR AG, Baden (CH)

(72) Inventor: Walter Haller, Wettswil (CH)

(73) Assignee: CHE-MOTOR AG, Baden (CH)

(21) Appl. No.: 19/100,400

(22) PCT Filed: Aug. 30, 2023
(86) PCT No.: PCT/EP2023/073800

§ 371 Date: Jan. 31, 2025

(30) Foreign Application Priority Data
Aug. 31, 2022 (WO) PCT/EP2022/074158

(51) Int. Cl. H02K 7/10; B60K 6/26; B60K 6/46; B60K 6/543; B60K 17/12; H02K 7/00; H02K 16/00

(52) U.S. Cl. CPC H02K 7/10; B60K 6/26; B60K 6/46; B60K 6/543; B60K 17/12; H02K 7/003; H02K 16/00; B60K 2006/266; B60Y 2200/92

(57) ABSTRACT

The present disclosure relates to an electromechanical apparatus (100) and to a transmission unit comprising the electro-mechanical apparatus (100) for changing motion parameters and to a vehicle comprising the transmission unit, the electro-mechanical apparatus (100) comprising a first rotating electromechanical ma-chine (110) comprising a first stator (112) and a first rotor (120), a second rotating electromechanical machine (130) having a smaller radial extension than the first rotating electromechanical machine (110) and comprising a second stator (132) and a second rotor (140), wherein the second rotating electromechanical ma-chine (130) is arranged radially within the first rotating electromechanical ma-chine (110) thereby forming an interleaving region (176) of the electromechanical apparatus (100), and wherein the first stator (112) and the second stator (132) are ironless, and wherein the first rotor (120) and the second rotor (140) are per-manent-magnet rotors or rotors comprising a winding for electrical excitation.

### FIELD OF THE DISCLOSURE

The present disclosure relates to an electromechanical apparatus, to a transmission unit comprising the electromechanical apparatus and to a vehicle comprising the transmission unit. Specifically, the present disclosure relates to an electromechanical apparatus comprising a first rotating electromechanical machine and a second rotating electromechanical machine, which are arranged coaxially with respect to each other, and wherein the second rotating electromechanical machine is arranged radially within the first rotating electromechanical machine thereby forming an interleaving region of the electromechanical apparatus. Further, the present disclosure relates specifically to a transmission unit comprising the electromechanical machine with the first and second rotating electromechanical machines and to a vehicle, which comprises the transmission unit.

### BACKGROUND OF THE DISCLOSURE

Rotating electromechanical apparatuses, such as electric motors and electric generators, are well known and used in many domestic, industrial and automotive applications and are available in many sizes and types, depending on their intended use. One example of such an electromechanical apparatus is a three-phase AC motor. In such electric motors, an alternating current (AC) applied to an electrical winding of a stator generates a rotating electromagnetic field, which induces a torque in a rotor. The rotor has, for example, a set of permanent magnets, which interact with the rotating electromagnetic field, rotor coils or rotor windings, rotor conductors through which an induced current generates an electromagnetic field, or soft magnetic materials in which non-permanent magnetic poles of the rotor are induced.

In the automotive industry vehicles with internal combustion engines and conventional drivetrains with discrete ratios make up the bulk of the vehicle production. The internal combustion engine operates mostly at a non-optimal working point, as the rotating speed of the combustion engine is mechanically coupled to the speed of wheels via a drivetrain. Clutches are needed for the starting of the internal combustion engine and shifting between different gears. Internal combustion engines are critical, as they use fossil fuels and therefore produce CO2. Fuel consumption and CO2 output could be significantly reduced, if the internal combustion engine could operate at the best possible working point. One possible solution, namely mechanical continuous gears have failed in the automotive industry in a wider use due to friction and wear problems.

Vehicles with full electrical drivetrain are introduced to the marked by different manufacturers in a wide range. Their propagation in the market is limited by the operating range, by the production of batteries and by the availability of charging stations.

Hybrid vehicles comprise an internal combustion engine and an electrical engine. The internal combustion engine is for example coupled by a mechanical transmission unit with the wheels. A mechanical gear with discrete ratios may connect the combustion engine and the electrical engine or the electrical engine with the mechanical transmission unit. Other variations of a hybrid vehicle are also conceivable.

Electric three phase motors or generators typically have a stator, which has a stator iron, and a stator winding, the stator winding being arranged inside slots of the stator iron. The stator winding comprises conductors in many forms, such as for example Litz wires, which are wound inside the stator in the slots of the stator iron, or single hairpin wire segments, which are inserted into the slots of the stator iron and then electrically joined together, for example by using laser welding.

In the conventional electromechanical apparatus, the stator iron comprises a bundle of metal laminations or a stack of metal sheets. An electrical insulation between the sheets reduces eddy currents. The bundle of laminations or the stack of sheets conventionally comprises slots in which the stator windings are arranged.

A conventional electromechanical apparatus, which comprises a plurality of electric motors or electric generators, may have a serial or parallel connection between the various electric motors or electric generators. For example, one electric generator is powered by an internal combustion engine for the production of electric current. This electric current is transmitted to an electrical motor for driving a different shaft of a machinery. The electrical generator and the electrical engine are in this scenario two different electromechanical machines, which are placed at different locations within the machinery. The electrical generator and the electrical engine require therefore a lot of installation space within the machinery.

Up to now it is not possible to develop powerful electromechanical machines with small dimensions and high power output, in particular electromechanical machines which combine the functionality of an electromechanical engine and an electromechanical generator.

The international patent application from the same applicant having the international application number PCT/EP2021/057125 with the title “rotating electromechanical apparatus and method of manufacture of stator winding” is herewith incorporated by reference in its entirety. The international patent application from the same applicant having the international application number PCT/EP2022/057160 with the title “ring cylindrical casing and method for producing a ring cylindrical casing of a rotating electromechanical apparatus” is herewith incorporated by reference in its entirety.

### SUMMARY OF THE DISCLOSURE

It is an object of the present disclosure to provide an electromechanical apparatus, a transmission unit comprising the electromechanical apparatus and a vehicle comprising the transmission unit. In particular, it is an object of the present disclosure to provide an electromechanical apparatus, a transmission unit comprising the electromechanical apparatus and a vehicle comprising the transmission unit, which do not have at least some of the disadvantages of the prior art.

According to the present disclosure, these objects are addressed by the features of the independent claims. In addition, further advantageous embodiments follow from the dependent claims, claim combinations and the description and figures.

According to the present disclosure, an electromechanical apparatus for changing motion parameters is specified. The electromechanical apparatus typically comprises a first rotating electromechanical machine comprising a first stator and a first rotor, which is arranged to be rotatable with respect to a common axis of rotation. The electromechanical apparatus further comprises a second rotating electromechanical machine having a smaller radial extension than the first rotating electromechanical machine and comprising a second stator and a second rotor, which is arranged to be rotatable with respect to the common axis of rotation. In an embodiment, the first rotating electromechanical apparatus is an electrical engine or an electrical generator and/or the second rotating electromechanical apparatus is an electrical engine or an electrical generator. In a further embodiment, the electromechanical apparatus comprises a combination of an electrical engine and an electrical generator, wherein the first rotating electromechanical machine is the electrical engine and the second rotating electromechanical machine is the electrical generator or vice versa.

According to the present disclosure, the rotating electromechanical machines are arranged such that their axis of rotation are arranged coaxially, both rotors rotate around the common axis of rotation. According to the present disclosure, the second rotating electromechanical machine is arranged radially within the first rotating electromechanical machine, preferably entirely within the first rotating electromechanical machine, thereby forming an interleaving region of the electromechanical apparatus. In other words, the first rotating electromechanical machine encloses the second rotating electromechanical machine. The interleaving region is the axially extending portion of the electromechanical apparatus, which comprises the first rotating electromechanical machine and the second rotating electromechanical machine. Arranged radially within means for example that the magnets of the rotor and the windings or coil of the stator of the second rotating electromechanical machine is enclosed by the first rotating electromechanical machine. Other parts of the second rotating electromechanical machine, like an input/output shaft may be arranged outside or may extend outside.

According to the present disclosure, the first stator and the second stator are ironless. An ironless rotating electromechanical machine has no material of high magnetic permeability inside or extending into a region of its coil/windings. Ironless rotating electromechanical machines preferably comprise also a stator iron to direct the magnetic flux. This stator iron is typically of ring cylindrical form, lying radially inside or outside of the windings or coil opposite to the rotor. In other words, an ironless stator does not mean that the entire stator is free of iron; it only means that the portion which comprises the coil or windings of the stator is free of iron. Ironless electromechanical machines are radially very compact, have small radial dimensions and can provide high torque and high power output.

For example, an ironless rotating electromechanical machine has no material of high magnetic permeability inside or extending into a region of its coil and/or windings, in particular of the stator of the electromechanical machine, which comprises the coils and/or windings. In other words, ironless means that the portion which comprises the coil and/or windings of the stator is free of iron and/or free of ferromagnetic materials, and/or free of a material having a magnetic permeability of for example 4 or higher, preferably of 40 or higher, more preferably of 300 or higher.

The portion of the first stator of the electromechanical machine, which comprises the coils and/or windings has no material of high magnetic permeability inside and/or is free of iron and the portion of the second stator of the electromechanical machine, which comprises the coils and/or windings has no material of high magnetic permeability inside and/or is free of iron.

In an embodiment, the material of the first stator and/or the second stator inside or extending into a region of its respective coil has magnetic permeability μᵣ of less than 300, preferably of less than 40, even more preferably of less than 4. The material inside or extending into a region of the coils of the ironless stators is for example a plastic material, a composite material, a resin material and/or a metallic material having the above described magnetic permeability property, providing at least partially support for the coils and/or windings of the respective stators.

According to the present disclosure, the first rotor is a permanent-magnet rotor or a rotor comprising a winding for electrical excitation, and the second rotor is a permanent-magnet rotor or a rotor comprising a winding for electrical excitation. It is also important that the rotor is of small radial dimensions for not foiling the advantage of the compact stator. Permanent magnet rotors enable designs of the rotors of small radial dimension. Also rotors with rotor coils or windings for electrical excitation can be designed with small radial dimensions. The radial dimension of the rotor is preferably of the same range than the radial dimension of the stator, more preferably smaller than the radial dimension of the stator, and even more preferably smaller than half the radial dimension of the stator.

Ironless stators together with radially compact rotors enable the design of electromechanical machines with small radial dimension, forming a “ring-motor”. Ring motors can be stacked into each other. Such a motor cascade, comprising for example the first and second rotating electromechanical machine, has as maximum outer dimension the outer dimension as the first rotating electromechanical machine, which encloses the second rotating electromechanical machine.

The extension of the active gap between the corresponding stator and rotor determines the torque and power output of the corresponding rotating electromechanical machine. For example, at a comparatively large diameter more magnets can be placed in the circumference of the rotor, which increases the torque or power output of this rotating electromechanical machine. With the use of the relatively radially small first rotating electromechanical machine, the second electromechanical machine, arranged within the first rotating electromechanical machine, can have still a relatively large active diameter, allowing high torque and power also for the second electromechanical machine.

It is of great advantage for the electromechanical apparatus, when two rotating electromechanical machines are, as disclosed herein, arranged coaxially and interleaving with respect to each other. The overall installation space of the disclosed electromechanical apparatus is significantly smaller compared to a conventional design, in which two electromechanical machines are for example arranged next to each other. For applications, where the installation space is of high importance, as for example in automotive applications, the disclosed electromechanical apparatus reduces the required installation space compared to a conventional design.

In particular, the electromechanical apparatus as disclosed herein can be built in compact form comparable to or even smaller than a conventional mechanical gear unit of a vehicle, such as car or truck. This enables to replace the mechanical gear unit with the electromechanical apparatus as disclosed herein.

Further advantages of the present disclosure are to provide a transmission unit for the vehicle, which enables to separate an internal combustion engine mechanically completely from a drive train, which enables to operate the internal combustion engine during operation at an optimized working point. Furthermore, a transmission unit can be provided for upgrading a conventional vehicle to a hybrid vehicle. Equipped with the transmission unit it is possible to reduce the consumption of fuel, to enable a partial operation as full electrical driven vehicle, and/or to boost the combustion power by additional battery power at no disadvantages in space requirement.

According to an embodiment, the first rotating electromechanical machine and the second rotating electromechanical machine are both designed as an internal rotor electromechanical machine, and wherein an input shaft, which is configured to be coupled to one of the first rotor or the second rotor, is arranged coaxially with respect to an output shaft, which is configured to be coupled to the other of the first rotor or the second rotor. An internal rotor electromechanical machine has the rotor arranged radially within the stator. This embodiment provides the advantage that the input shaft and the output shaft enter and/or leave the electromechanical apparatus in the rotational center along and coaxially with the common axis of rotation. The input shaft and the output shaft are also arranged coaxially with respect to each other. According to this embodiment, both rotors are surrounded by the stators, which are arranged both outermost on the respective rotating electromechanical machine.

According to another embodiment, the first rotating electromechanical machine is designed as an internal rotor electromechanical machine, and the second rotating electromechanical machine is designed as an external rotor electromechanical machine, and wherein an input shaft, which is configured to be coupled to one of the first rotor or the second rotor, is arranged eccentrically with respect to an output shaft, which is configured to be coupled to the other of the first rotor or the second rotor. An internal rotor electromechanical machine has the rotor arranged radially within the stator. An external rotor electromechanical machine has the rotor arranged radially outside the stator. According to this embodiment, both rotors are surrounded by the stators, which are arranged innermost and outermost. For example, the permanent magnets of the second rotating electromechanical machine can be placed radially inside a rotor shell, which simplifies the arrangement of the magnets on the rotor shell, because the centrifugal force acting on the magnets is absorbed directly by the rotor shell. In this embodiment the stator of the second electromechanical machine is placed inside the two rotors.

It is a topological advantage, that the second stator must enter the machine in the center along the axis of rotation such that the second rotor can be supported advantageously, preferably on both axial ends. The second stator must withstand the torque of the electromagnetic force and should feed the cooling fluid and additionally in some embodiments conductors of the electrical current. Therefore, the second rotor of the second electromechanical machine cannot leave the apparatus in the center, as the center is filled by the second stator. In an embodiment, the second rotor may have the shape of a hollow shaft which comprises a gearing and which is configured to engage with the eccentrically arranged output shaft via the gearing. In this embodiment, also the output shaft may comprise a gearing. A gear stage, for example a spur gear stage or a bevel gear stage, is formed between the hollow shaft of the rotor and the output shaft. The gear stage has for example a gear transmission ratio of 4:1.

In an embodiment, the input shaft is arranged on one axial end of the electromechanical apparatus, and the output shaft is arranged on the other opposing axial end of the electromechanical apparatus. For example, the input shaft is connected to the first rotor and the output shaft is connected to the second rotor. This arrangement of the input shaft in combination with the output shaft enables to position bearings of the electromechanical apparatus relatively close to the axis of rotation, which reduces wear of the bearings. The input shaft and/or the output shaft are, for example, integrally formed with the respective rotor, form fitted, press fitted, screwed etc. or arranged differently on the respective rotor.

According to an embodiment, the electromechanical apparatus comprises a gear stage arranged between at least one of: the input shaft and the first rotor, the input shaft and the second rotor, the first rotor and the output shaft and the second rotor and the output shaft. The gear stage creates the possibility to change rotation parameters between the input shaft and the first rotor and between the second rotor and the output stage directly within the electromechanical apparatus, which is in particular advantageous with respect to installation space requirements. The gear stage further enables to change the rotation parameters for an ideal operation of the respective rotating electromechanical machine, in particular for operating a combustion engine providing input power in a favorable speed range. The gear stage is for example a spur gear stage or a bevel gear stage.

According to an embodiment, the first stator and the second stator comprise each a helical lamination stack of a helically wound strip of magnetically permeable material, having multiple turns, wherein the strip comprises two main surfaces and two side surfaces, wherein at least one of the two main surfaces comprises an insulation coating. In a further embodiment, the first rotor and the second rotor comprise each a helical lamination stack of a helically wound strip of magnetically permeable material, having multiple turns, wherein the strip comprises two main surfaces and two side surfaces, wherein at least one of the two main surfaces comprises an insulation coating. The strip has the shape of an extended rectangular cuboid, bevor being formed into the helical shape, having the two main surfaces, the two side surfaces (which are typically smaller than the main surfaces) and two end surfaces, the tips. According to this embodiment, at least one of the two main surface of the extended cuboid comprises the insulation coating. In other words, it is possible that one of the two main surfaces comprises the insulation coating, for example, the upper main surface or the lower main surface, or both of the main surfaces can comprise the insulation coating. Typical for an ironless stator is, that the stator iron is of a simple ring-cylindrical form. This enables the use of the very cost advantageous helical lamination stack as described above instead of the conventional lamination stacks with complex form including slots for the winding which have to be made for example by pressing technique or laser cutting.

In the helical shape, the main surface of a first turn or winding of the helically wound strip faces a main surface of a directly neighboring or next turn or winding of the helical strip. One of the side surface faces radially inwards, i.e. towards the common axis of rotation, and the other side surface faces radially outwards, i.e. away from the common axis of rotation. This way, each winding or turn of the helically wound strip, if at all, is only in contact with the neighboring windings or turns via the respective coated main surface. The insulation coating has therefore the effect to avoid guiding of induced currents from one winding directly to the next winding, which reduces eddy currents produced by a stator winding of the electromechanical apparatus during its operation as desired. Compared to a conventional lamination stack of ring cylindrical sheets, there is still induced current flowing from one winding to the next, but instead of flowing directly in axial direction to the next winding (for example 0.3 mm) the induced current has to flow a full circumference and has therefore no significant influence on the performance of the rotating electromechanical machines. The helically wound strip of the magnetically permeable material follows the shape of a helix to form the helical lamination stack having multiple turns. It is preferred that the helically wound strip is made from an iron alloy.

An advantage of having an ironless stator is that the rotating electromechanical machine has a higher electric efficiency and requires less space in radial dimension, and in particular wherein it can be manufactured in a ring-cylindrical shape of reduced radial dimensions. The increased electrical efficiency is caused by smaller losses in the narrow stator iron. The small dimension of the ring cylindrical ironless stators also creates the advantageous effect of a reduced weight of the corresponding rotating electromechanical machine. Furthermore, the rotating electromechanical machine with the ironless stator does not have a pronounced cogging effect. However, to date, ironless stators have typically been applied mainly to electric motors of small sizes and power or which require high positioning accuracy. Similar considerations also apply to the first and second rotor comprising the helical lamination stack according to this embodiment. The first and second rotating electromechanical machine according to this embodiment provide the required electromagnetically properties for the usage of ironless stators and corresponding rotors also for high power industrial or automotive applications.

According to an embodiment, the first stator and the second stator comprise each a continuous hairpin winding having at least two winding layers or comprise each a continuous wave winding having at least two winding layers. In a further embodiment, the first rotor comprises permanent magnets or a continuous hairpin winding having at least two winding layers or comprises a continuous wave winding having at least two winding layers. In a further embodiment, the second rotor comprises permanent magnets or a continuous hairpin winding having at least two winding layers or comprises a continuous wave winding having at least two winding layers. The coil for electrical excitation in the first stator and the second stator according to this embodiment can be the continuous hairpin winding. The coil for electrical excitation in the first rotor and the second rotor according to this embodiment can be the continuous hairpin winding.

The continuous hairpin winding comprises wires, which are hairpin-shaped an provide straight wire segments, which run in parallel to the common axis of rotation. Next to a first straight segment, on one or both ends of the straight segment, the wire is folded and bent such that a subsequent second straight segment runs anti-parallel at a distance, preferably a half-pole distance, to the first straight segment. The hairpin winding is continuous in that each hairpin wire section, defined by comprising one or two or more straight segments, is continuous with the next hairpin wire section. In particular, there is no necessity for electrical joins created by welding, soldering, or similar technique between the hairpin wire sections. However, the wires of the continuous hairpin winding, i.e. input lead wires and/or output lead wires, may ultimately be joined by some welding or similar technique at their ends, e.g. for star-grounding or delta-connecting different phases of the continuous hairpin winding. The continuous hairpin winding can have two layers of hairpin wire one upon the other when seen in a radial direction. A given wire changes position, for example, from a first layer to a second layer or vice versa when seen around the continuous stator winding such that the first straight segment is arranged in the first layer and then is folded and bent such that the second or subsequent or next straight segment is arranged in the second layer.

The continuous hairpin winding is up to 30% more effective regarding torque and power compared to the wave winding due to the superior layout of the wire segments. In the hairpin design, the wire segments are, for example, parallel within the area of the permanent magnets, conducting the current parallel to the magnet poles, whereas in a wave design the conductors only partially overlap with the magnetic field, which may reduce the driving force exerted by the permanent magnetic field onto the wave winding during motor operation or may reduce the effective magnetic field by inducing counter currents in the wave winding during generator operation.

The continuous hairpin winding or the continuous wave winding, according to this embodiment, function as coils for the corresponding rotating electromechanical machines and require relatively little radial installation space, which helps to arrange the first and second rotating electromechanical machine coaxially and interleaving with respect to each other without the need for large radial dimensions of the resulting electromechanical apparatus.

According to an embodiment, the first rotating electromechanical machine has a first machine thickness from its maximum radial outer extension at the interleaving region to its minimum radial inner extension at the interleaving region in a range from 30 mm to 15 mm, preferably from 25 mm to 20 mm, more preferably of 22 mm.

According to an embodiment, the second rotating electromechanical machine has a second machine thickness from its maximum radial outer extension at the interleaving region to its minimum radial inner extension at the interleaving region in a range from 30 mm to 15 mm, preferably from 25 mm to 20 mm, more preferably of 22 mm.

The machine thickness is the radial distance at the interleaving region of the electromechanical apparatus between a housing or shell of the outer rotor or stator and a housing or shell of the inner rotor or stator of one of the rotating electromechanical machines. For example, the first rotating electromechanical machine comprises a stator shell including cooling means, a helical lamination stack, a continuous hairpin winding as coil, magnets and a rotor shell, wherein the stator shell, the helical lamination stack and the coil form the stator and the magnets or the rotor coil and the rotor shell form the rotor. The radial distance between the radial outermost stator shell and the innermost rotor shell is according to this embodiment the machine thickness. The parts as described above enable the first and second rotating electromechanical machine to be built advantageously with a small machine thickness as defined above, without compromises in power output.

According to an embodiment, the first rotating electromechanical machine has a maximum radial outer diameter at the interleaving region in a range from 100 mm to 1000 mm, preferably from 150 mm to 350 mm, more preferably of 300 mm. The maximum radial outer diameter of the first rotating electromechanical machine is the distance across the electromechanical apparatus at the interleaving region and therefore the overall required installation diameter of the electromechanical apparatus.

According to an embodiment, a ring-shaped axially extending gap at the interleaving region between the first rotating electromechanical machine and the second electromechanical machine has a thickness of less than 10 mm, preferably of less than 5 mm. The ring-shaped axially extending gab defines the distance between the first rotating electromechanical machine and the second rotating electromechanical machine. Having a relatively small gap at the interleaving region reduces the required radial installation space of the entire electromechanical apparatus. In particular, a relatively small gap of for example 5 mm is only achievable, because the tolerances and the support via the bearings enable precise rotation of the different rotating parts during operation of the electromechanical apparatus. Further, it is required that the gap provides air flow for cooling between the first and second rotating machine.

In an embodiment, the electromechanical apparatus comprises at its first axial end at least one first bearing and at its second opposing axial end at least one second bearing, wherein the first bearing and the second bearing are arranged between two parts selected from a group consisting of: the first stator, the second stator, the first rotor and the second rotor. According to this embodiment, the first stator, the second stator, the first rotor and the second rotor are all on both axial ends coupled by bearings mounted concentrically to the common axis of rotation which increases stability, reduces vibrations and helps to balance the different parts of the electromechanical apparatus, thereby enabling high torque and power output especially at high rotation speeds of the electromechanical apparatus.

According to an embodiment, a support of the first rotor comprises a first bearing, which is arranged between the first stator and the first rotor on one axial end of the electromechanical apparatus, and a second bearing, which is arranged between the second rotor and the first rotor on the other axial end of the electromechanical apparatus. According to this embodiment, the first rotor is advantageously supported on both axial ends, which increases advantageously stability and accuracy of the rotation, in particular for high rotational speeds. This embodiment enables the first rotor to rotate around the common axis of rotation with respect to the first and second stator. According to this embodiment, the first rotor is supported, by the first and second bearing, on the first stator and on the second rotor of the second rotating electromechanical machine. This enables to support the first rotor on both axial ends of the first rotor, which increases rotating stability and reliability during operation of the first rotating electromechanical machine.

According to an embodiment, the support of the second rotor comprises a first bearing arranged between the first stator and the second rotor on one axial end of the electromechanical apparatus, and a second bearing arranged between the second rotor and the first rotor on the other axial end of the electromechanical apparatus. The support of the second rotor further comprises a second bearing arranged between the second rotor of the second rotating electromechanical machine and the first rotor of the first rotating electromechanical machine. The second rotor is supported, by the first and second bearing, on the second stator of the second rotating electromechanical machine and on the first rotor of the first rotating electromechanical machine. According to this embodiment, the second rotor is supported on both axial ends, which increases rotating stability and reliability during operation of the second rotating electromechanical machine.

According to an embodiment, the radially innermost part of the second rotating electromechanical machine is at least at the interleaving region designed as a hollow shaft, thereby forming a cavity radially within the second rotating electromechanical machine. The cavity is a result of the radially compact first and second electromechanical machines. It demonstrates even without further calculations that the electromechanical apparatus is of low weight, as a significant volume is empty and not filled with heavy metals. Low weight is a further advantage of the disclosed apparatus. Low weight is an important advantage for many applications, in particular in the automotive industry.

In an embodiment, the first rotating electromechanical machine and also the second rotating electromechanical machine are both configured to operate in engine mode as electric engines. In this embodiment, the output shaft of the first rotating electromechanical machine and the output shaft of the second rotating electromechanical machine can be driven completely independently. An application of such an apparatus is, for example, in the high-end automotive technology with individual power supply for each wheel of a powered axle. In an embodiment, the first rotating electromechanical machine and the second rotating electromechanical machine are controlled such that the resulting rotational speed and the resulting power of the respective powered wheels, powered by the corresponding output shaft, is chosen for an optimal corner stability/track alignment in dependence of the current track, the current position of the wheels on the track. In an embodiment, the required electrical energy to drive the first and second rotating electromechanical machine is supplied, for example, by a battery and/or by an internal combustion engine, which is mechanically connected to a generator. According to this embodiment, it is possible to improve the corner stability by applying, for example, higher torque to the outer wheel via the first or second rotating electromechanical machine. The disclosed apparatus has significant advantages compared to the state-of-the-art solution with two separate engines, requiring about twice as much installation space.

In an embodiment, the first stator comprises a first stator shell, a first lamination stack, preferably comprising a first helical wound strip, and a first coil, preferably comprising a first continuous hairpin winding, and wherein the second stator comprises a second stator shell, a second lamination stack, preferably comprising a second helical wound strip, and a second coil, preferably comprising a second continuous hairpin winding. According to this embodiment, the first stator shell has a different radial extension (radius) compared to the second stator shell, thereby enabling that other components of the electromechanical apparatus may be arranged between the first stator and the second stator. In a further embodiment, at least one of the rotors, preferably both rotors of the electromechanical apparatus, is/are arranged between the first stator and the second stator.

According to another aspect of the present disclosure, a transmission unit for changing motion parameters is specified. Motion parameters are for example: rotation speed, acceleration and/or deceleration of the rotation, torque, or any combination of such parameters. The transmission unit comprises an electromechanical apparatus as described above and hereinafter and an electrical component, which is configured to receive electric current, generated during operation of the first or second rotating electromechanical machine, and configured to transmit electric current to the other of the first or second rotating electromechanical machine, to drive an output shaft. In other words, the electrical component of the transmission unit is configured to transfer the received electric energy from the first or second rotating electromechanical machine, which works in generator mode, to the other of the first or second rotating electromechanical machine, which works in engine mode.

The transmission unit further comprises a transmission unit battery connected to the electrical component and configured to store electrical power received from the electromechanical apparatus and configured to provide electrical power to the electromechanical apparatus, in particular to the rotating electromechanical machine configured to drive the output shaft. The transmission unit battery may further be configured to at least one of: to buffer differences in power requirements of the two rotating electromechanical machines, to supply power to the output shaft, to start a combustion engine, to enable pure electric driven mode of a vehicle comprising the transmission unit, to regain power in break mode, to charge power by a stationary external electrical power station, and any combination of these features.

According to an embodiment, the electrical component comprises a converter, which is configured to transform the received electric current having first electric properties, in particular a first AC frequency, to the desired electric current having second electric properties, in particular a second AC frequency, for the rotating electromechanical machine, configured to drive the output shaft. According to this embodiment, the electric component does not only transmit the received electrical current to the corresponding rotating electromechanical machine, but also modifies the electric properties of the received electric current to the desired electric current for the corresponding rotating electromechanical machine, which is configured to work in engine mode.

The first rotating electromechanical machine and the second rotating electromechanical machine can operate completely independent in regard of rotation speed. They are not coupled by a mechanical transmission with fixed or discrete steps of ratios as for example in a gear connection. Both machines can operate at their optimized working point completely independent from each other, despite of being arranged within each other. The transmission unit operates therefore as a continuous “gearbox”, limited not by mechanical requirements but only by limitations of the electrical power-and frequency conversion. In an automotive application, an internal combustion engine, which may drive the input shaft of the electromechanical apparatus, can operate at its optimal working point for low fuel consumption and CO2 emission independent of the speed of the wheels. The internal combustion engine may be turned off, as long as power from the transmission unit battery and/or from a vehicle battery is available.

According to an embodiment, the electrical component comprises a control unit for controlling the properties of the electric current transmitted to the first or second rotating electromechanical machine such that a desired transmission ratio, in particular variable or continuously variable transmission ratio, between the input shaft of the first rotating electromechanical machine and the output shaft of the second rotating electromechanical machine is realized. The transmission ratio is, for example, the ratio of the rotational speed of the output shaft to the rotational speed of the input shaft. The electrical component is, according to this embodiment, configured to modify the properties of the electric current, which is transmitted to the rotating electromechanical machine working in engine mode, for example, by changing the frequency of the electric current. The desired transmission ratio is, for example, determined by input parameters received in the control unit, which are transformed by the control unit into control commands for the electrical component.

According to a further aspect of the present disclosure, a vehicle, e.g. passenger car or truck or motorbike or motor plane, in particular a vehicle comprising an internal combustion engine or hybrid vehicle or electric vehicle, is specified, which comprises a transmission unit as described above or hereinafter.

According to an embodiment, the vehicle comprises an internal combustion engine, which is configured to propel an input shaft of the electromechanical apparatus, a drive train, which is mechanically connected to an output shaft of the electromechanical apparatus and which is configured to propel the vehicle. The vehicle may further comprise a vehicle battery, which is electrically connected to the electrical component and configured to store electrical power received from the electromechanical apparatus and configured to provide electrical power to the vehicle, in particular to the electromechanical apparatus. The vehicle battery is in an embodiment the same battery as the transmission unit battery. In another embodiment, the vehicle battery is an additional battery. The battery is electrically connected with the electromechanical apparatus and is configured to receive at least temporarily a portion of the electric current, which is produced by the rotating electromechanical machine working in generator mode, and/or to provide electrical energy to the rotating electromechanical machine working in engine mode. According to this embodiment, the vehicle battery is configured to work as an electric buffer for the vehicle. Further, the vehicle battery may additionally provide electric energy to the rotating electromechanical machine working in engine mode.

In additional or alternative embodiments, the vehicle battery may be used as a storage medium for electric energy, which can be charged from an external source of electricity, such as electric power network and/or photovoltaic cells.

According to an additional aspect of the present disclosure a conversion kit is specified, which comprises the electromechanical apparatus as described above and hereinafter or which comprises the transmission unit as described above and hereinafter. The conversion kit is used to convert a conventional internal combustion engine vehicle into a hybrid vehicle. The electromechanical apparatus replaces for example a conventional gearbox of a conventional drivetrain. For example, the input shaft of the electromechanical apparatus is connected to the internal combustion engine and the rest of the drivetrain of the vehicle (without the gearbox) is connected to the output shaft of the electromechanical apparatus.

The internal combustion engine can work at its optimal working point and the required transmission is performed by the newly installed transmission unit.

### BRIEF DESCRIPTION OF THE DRAWINGS

The present disclosure will be explained in more detail, by way of example, with reference to the drawings in which:

FIG. 1: shows schematically a longitudinal section view of an electromechanical apparatus according to a first embodiment of the present disclosure,

FIG. 2: shows schematically a cross section view in a radial plane of the electromechanical apparatus according to the first embodiment of the present disclosure,

FIG. 3: shows schematically a longitudinal section view of an electromechanical apparatus according to a second embodiment of the present disclosure,

FIG. 4: shows a side view of the electromechanical apparatus according to the second embodiment of the present disclosure,

FIG. 5: shows schematically in a perspective view a helical lamination stack according to a first exemplary embodiment,

FIG. 6: shows schematically in a perspective view an electromechanical apparatus according to an embodiment of the present disclosure with cut-away sections to show the interior of the apparatus,

FIG. 7: shows schematically in perspective view a cylindrical continuous hairpin winding according to a first exemplary embodiment,

FIG. 8: shows schematically a transmission unit comprising the electromechanical apparatus according to an exemplary embodiment,

FIG. 9: shows schematically a vehicle comprising the transmission unit according to an exemplary embodiment.

### DETAILED DESCRIPTION OF THE EMBODIMENTS

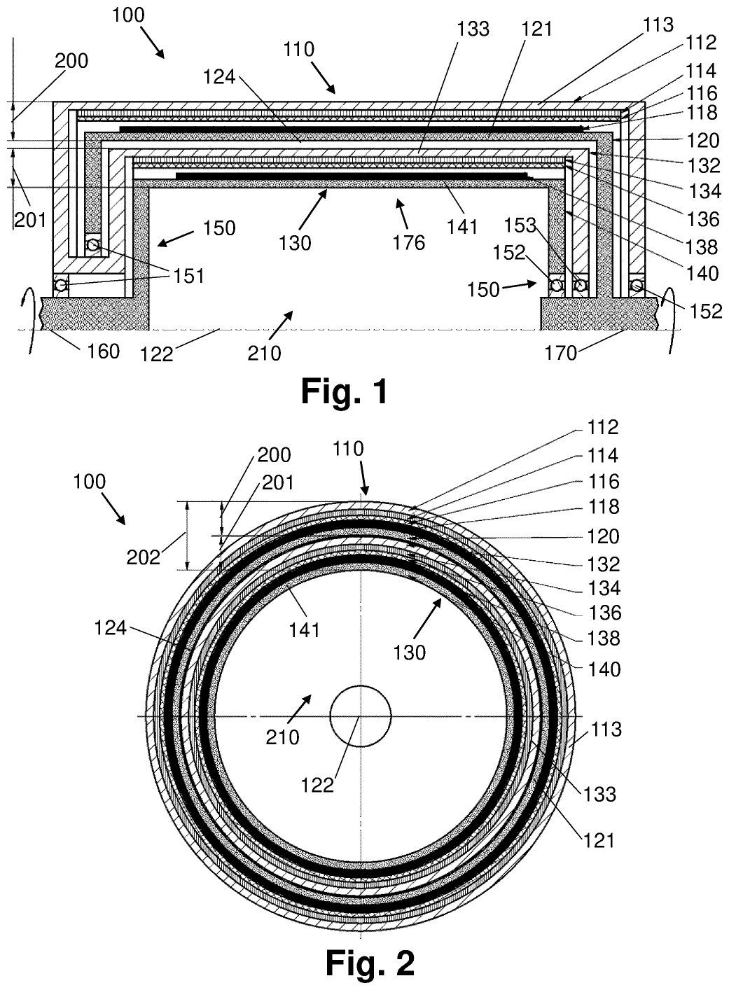

FIG. 1 and FIG. 2 show schematically an electromechanical apparatus 100 according to a first exemplary embodiment. FIG. 1 shows a longitudinal section view and FIG. 2 shows a radial cross section view of the electromechanical apparatus 100. The electromechanical apparatus 100 comprises a first rotating electromechanical machine 110 and a second rotating electromechanical machine 130. The first rotating electromechanical machine 110 comprises a first stator 112 and a first rotor 130. The first stator 112 comprises a first stator shell 113, a first lamination stack 114, preferably comprising a first helical wound strip 115, and a first coil 116, preferably comprising a first continuous hairpin winding 117. The first rotor 120 comprises a first rotor shell 121 and first magnets 118. The second rotating electromechanical machine 130 comprises a second stator 132 and a second rotor 140. The second stator 132 comprises a second stator shell 133, a second lamination stack 134, preferably comprising a second helical wound strip 135, and a second coil 136, preferably comprising a second continuous hairpin winding 137. The second rotor 140 comprises a second rotor shell 141 and second magnets 138.

According to another embodiment (not shown in the figures), the first rotor comprises, instead of the first magnets 118, a winding for electrical excitation, the winding for electrical excitation is preferably a continuous hairpin winding. It is additionally preferred that the second rotor comprises, instead of the second magnets 138, a winding for electrical excitation, the winding for electrical excitation is preferably a continuous hairpin winding. In this embodiment, the first rotor and the second rotor may also comprise each a respective lamination stack comprising a helical wound strip.

The first rotating electromechanical machine 110 as best shown in the FIGS. 1, 2 and 3, in particular the first rotor 120, is configured to rotate during operation around a common axis of rotation 122. The second rotating electromechanical machine 130, in particular the second rotor 140, is configured to rotate during operation around the common axis of rotation 122. Further, the figures show that the first rotating electromechanical machine 110 and the second rotating electromechanical machine 130 are arranged interleavingly with respect to each other, thereby forming an interleaving region 176. The interleaving region 176 is the axial extension of the electromechanical apparatus 100, in which the first rotating electromechanical machine 110 and the second rotating electromechanical machine 130 overlap. Arranging the two rotating electromechanical machines 110, 130 coaxially and in interleaving manner reduces advantageously the required installation space. The figures further show that the second rotating electromechanical machine 130 is arranged entirely within the first rotating electromechanical machine 110.

The stators 112, 132 of the respective rotating electromechanical machines 110, 130, are configured to guide the magnetic field within the corresponding rotating electromechanical machine 110, 130. The stator shells 113, 133 are configured to function as the housing of the stators 112, 132 and hold the other parts of the stators 112, 132 in place during operation of the electromechanical apparatus 100. The stator shells 113, 133 may additionally comprise cooling means (not shown in the figures) for cooling the respective electromechanical machines 110, 130. The lamination stacks 114, 134, comprising the helical wound strip 115, 135, which are configured to reduce eddy currents and increase the efficiency of the rotating electromechanical machine 110, 130. The coils 116, 136 are configured to guide electric current trough the corresponding stator 112, 132. In the embodiments as presented in the Figures, the coils 116, 136 preferably comprise the continuous hairpin winding 117, 137.

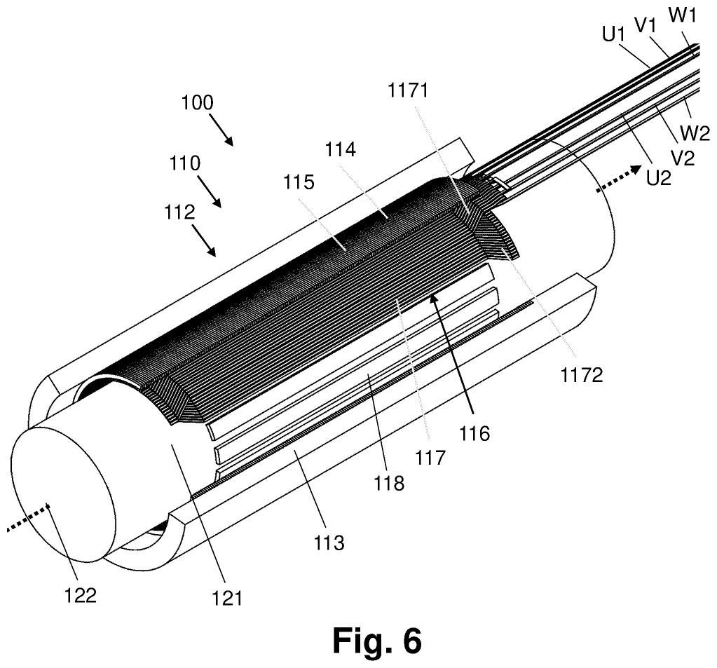

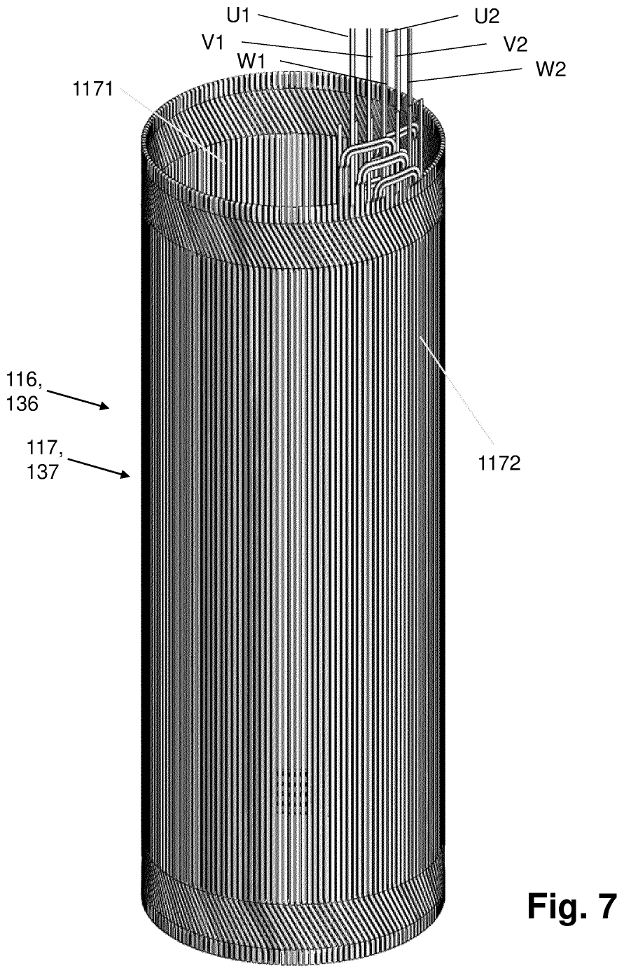

The continuous hairpin winding 117, 137, as best shown in the FIGS. 6 and 7, have at least two layers 1171, 1172 comprising wires, which are hairpin-shaped and provide straight wire segments, which run in parallel to the common axis of rotation 122. Next to a first straight segment, on one or both ends of the straight segment, the wire is folded and bent such that a subsequent second straight segment runs anti-parallel at a distance to the first straight segment. The hairpin winding 117, 137 is continuous in that each hairpin wire section, defined by comprising one or two or few straight segments, is continuous, i.e. in one piece, with the next hairpin wire section. In particular, there is no necessity for electrical joins created by welding, soldering, or similar technique between the hairpin wire sections. However, the wires of the continuous hairpin winding 117, 137 may ultimately be joined by some welding or similar technique at their ends, e.g. for star-grounding or delta-connecting different phases of the continuous hairpin winding.

The continuous hairpin winding 117, 137 has two layers 1171, 1172 of hairpin wire one upon the other when seen in a radial direction. A given wire changes position, for example, from a first layer 1171 to a second layer 1172 or vice versa when seen around the continuous hairpin winding 117, 137 such that the first straight segment is arranged in the first layer 1171 and then is folded and bent such that the second or subsequent or next straight segment is arranged in the second layer 1172. The continuous hairpin winding 117, 137 or the continuous wave winding, according to this embodiment, function as coils 116, 136 for the corresponding rotating electromechanical machines 110, 130, which require relative little radial installation space, which helps to arrange the first and second rotating electromechanical machine 110, 130 coaxially and in an interleaving manner with respect to each other without the need for huge radial dimensions.

The first rotating electromechanical machine 110 is configured to work as an electric motor or as a generator. This depends on the required application of the electromechanical apparatus 100. The second rotating electromechanical machine 130 is also configured to work as an electric motor or as a generator, which depends on the required application of the electromechanical apparatus 100.

FIGS. 1 and 2 show a first variant of the electromechanical apparatus 100. In this variation, the first rotating electromechanical machine 110 and the second rotating electromechanical machine 130 are designed as internal rotor electromechanical machines. In other words, the respective rotors 120, 140 are arranged radially within the respective stators 112, 132. According to this embodiment, an input shaft 160 of the electromechanical apparatus 100 is integrally formed with the second rotor shell 141. Different couplings between the input shaft 160 and the second rotor shell 141 are also conceivable. An output shaft 170 of the electromechanical apparatus 100 is, according to this embodiment, integrally formed with the first rotor shell 121. Different couplings between the output shaft 170 and the first rotor shell 121 are also conceivable. The first output shaft 160 and the second output shaft 170 are arranged coaxially with respect to each other and with respect to the common axis of rotation 122.

FIG. 1 further shows the support concept 150 comprising different bearings of the first embodiment of the electromechanical apparatus 100. As it can be seen, all of the bearings are arranged relatively close to the common axis of rotation 122, which advantageously reduces rolling speeds of the bearings and therefore increases lifespans of the bearings. The bearings comprise first bearings 151, which are arranged on one axial end of the electromechanical apparatus 100, and second bearings 152, which are arranged on the other opposing axial end of the electromechanical apparatus 100. Having the bearings 151, 152 on both axial ends increases the stability and accuracy of rotation, which enables to have relatively high rotational speeds of the rotors 120, 140. According to this embodiment, all parts of the electromechanical apparatus 100 are connected rotatable via bearings concentric to the common axis of rotation 122, which increases stability, reduces vibration and out of balance enabling high torque and power output especially at high rotation speeds.

FIG. 1 shows as support 150 for the first rotor 120 one first bearing 151 arranged between the first rotor shell 121 and the first stator shell 113. In other words, the support 150 is the bearing concept. The first stator shell 113 is in this embodiment coupled to the second stator shell 133 and the first bearing 151 of the first rotor 120 is arranged at the coupling portion. FIG. 1 further shows one second bearing 152 arranged on the opposite axial end between the first stator shell 113 and the first rotor shell 121, in particular, the output shaft 170, which is according to this embodiment coupled to the first rotor shell 121.

FIG. 1 further shows as support 150 for the second rotor 140 one first bearing 151 arranged between the second rotor shell 141 and the first stator shell 121, in particular between the coupling portion of the first stator shell 121 and the second stator shell 133. One second bearing 152 is arranged on the opposite axial end of the electromechanical apparatus 100 between the second rotor shell 141 and the first rotor shell 121, in particular, the output shaft 170, which is according to this embodiment coupled to the first rotor shell 121.

FIG. 1 further shows an additional third bearing 153 arranged between the second stator shell 133 and the first rotor shell 121, in particular, the output shaft 170, for additionally or alternatively supporting the second stator shell 133 with respect to the first rotor shell 121.

FIG. 2 shows the cross section through the interleaving portion 176 of the variant as shown in FIG. 1. FIG. 2 shows advantageously the thickness of the different rotating electromechanical machines 110, 130. The first rotating electromechanical machine 110 has a first machine thickness 200 extending from the first stator shell 113 to the first rotor shell 121. The second rotating electromechanical machine 130 has a second machine thickness 201 extending from the second stator shell 133 to the second rotor shell 141. An axial extending gap 124 is arranged between the first rotating electromechanical machine 110 and the second rotating electromechanical machine 130. The electromechanical apparatus 100 has an overall thickness 202 extending from the first stator shell 113 to the second rotor shell 141. In other words, the overall thickness is the sum of the first machine thickness 200, the second machine thickness 201 and the axially extending gap 124. The FIGS. 1 and 2 further show a cavity 210 arranged radially within the interleaving portion 176. The cavity is a result of the radially compact electromechanical machines 110, 130. It demonstrates even without further calculations that this electromechanical apparatus 100 is of low weight, as a significant volume is empty and not filled with heavy metals.

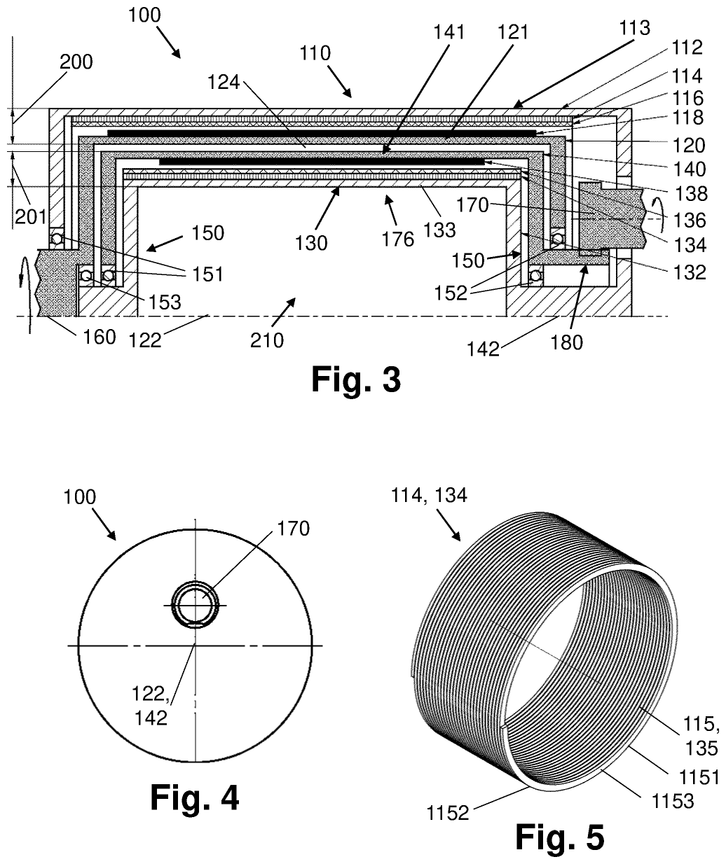

FIGS. 3 and 4 show the second variation of the electromechanical apparatus 100. According to this embodiment, the first rotating electromechanical machine 110 is designed as internal rotor electromechanical machines, and the second rotating electromechanical machine 130 is designed as external rotor electromechanical machine. In other words, second rotor 140 is arranged radially outside of the second stator 132. According to this embodiment, an input shaft 160 of the electromechanical apparatus 100 is integrally formed with the first rotor shell 121. Different couplings between the input shaft 160 and the first rotor shell 121 are also conceivable. An output shaft 170 of the electromechanical apparatus 100 is, according to this embodiment, coupled with the second rotor shell 131 via a mechanical gear stage 180, in particular a spur gear stage. The first output shaft 160 and the second output shaft 170 are not arranged coaxially with respect to each other; instead, they have an axle offset with respect to each other. The gear stage 180 enables to modify the rotational properties between the second rotor 140 and the output shaft 170.

FIGS. 3 shows, that the second stator 132 of the second electromechanical machine 130 enters the electromechanical apparatus 100 at the center of one axial end. This second stator 132 is located inside of two rotors 120, 140, but is according to this embodiment immotile. The second stator 132 is configured to absorb the torque of the electromechanical apparatus 100 and is configured to provide access to electrical connectors and cooling, for example water-cooling. The output shaft 170 can therefore not exit the electromechanical apparatus 100 coaxially with respect to the common axis of rotation 122 as shown in FIG. 1, because the center is occupied by the second stator 132. This problem is overcome as disclosed by adding an eccentrically arranged gear stage 180. With the gear stage 180, the output shaft 170 is shifted away from the center as best shown in FIG. 4.

FIG. 3 further shows the support concept 150 comprising different bearings of the second embodiment of the electromechanical apparatus 100. As it can be seen, all of the bearings are arranged relatively close to the axis of rotation 122, 142, which advantageously reduces rolling speeds of the bearings and therefore increases lifespans of the bearings. The bearings comprise first bearings 151, which are arranged on one axial end of the electromechanical apparatus 100 and second bearings 152, which are arranged on the other opposing axial end of the electromechanical apparatus 100. Having the bearings 151, 152 on both axial ends increases the accuracy and stability of rotation, which enables to have relatively high rotational speeds.

FIG. 3 shows as support 150 for the first rotor 120 one first bearing 151 arranged between the first rotor shell 121 and the first stator shell 113. This first bearing 151 of the first rotor 120 is arranged on the input shaft 160, which is according to this embodiment coupled to the first rotor shell 121. FIG. 3 further shows one second bearing 152 arranged on the opposite axial end of the electromechanical apparatus 100 between the first rotor shell 121 and the second rotor shell 141.

FIG. 3 further shows as support 150 for the second rotor 140 one first bearing 151 arranged between the second rotor shell 141 and the second stator shell 133. One second bearing 152 is arranged on the opposite axial end of the electromechanical apparatus 100 between the second rotor shell 141 and the second stator shell 133.

FIG. 3 further shows a third bearing 153 arranged between the second stator shell 133 and the first rotor shell 121, in particular, the input shaft 160, for additionally or alternatively supporting the second stator shell 133 with respect to the first rotor shell 121. Similarly as shown in the embodiment of FIG. 1, the first stator 112, the second stator 132, the first rotor 120 and the second rotor 140 are all on both axial ends coupled by bearings concentric with respect to the common axis of rotation 122, which increases stability, reduces vibration level and coming out of balance, thereby enabling high torque and power output even at high rotation speeds.

FIG. 4 shows in a side view of the second embodiment the particularly advantageous offset of the output shaft 170 with respect to the common axis of rotation 122.

FIG. 5 shows a perspective view of the first or second lamination stack 114, 134 as used for example in the first or second rotating electromechanical machine 110, 130. The helical lamination stack 114, 134 is formed out of the helically wound strip 115, 135 of magnetically permeable material, e.g. an iron alloy. The strip 115, 135 preferably has a rectangular cross-section. Thus, the strip 115, 135 has two main surfaces 1151 and two side surfaces 1152. The main surfaces 1151 are arranged parallel to each other and form the surfaces with the largest extension in terms of area. The side surfaces 1152 are also arranged parallel to each other. Further, the side surfaces 1152 are arranged perpendicular to the main surfaces 1151 and connect the two main surfaces 1152 with each other. The main surfaces 1151 and the side surfaces 1152 define the mantle of the strip 115, 135. The thickness of the strip 115, 135 is the short extension between the side surfaces 1152. The width of the strip 115, 135 is the short extension between the main surfaces 1151. The other or long extension of the main surfaces 1151 and the side surfaces 1152 defines a length of the strip 115, 135. The strip 115, 135 is closed or concluded by two end surfaces, which form the tips of the strip 115, 135. FIG. 5 further shows the insulation coating 1153, which is arranged on at least one of the two main surfaces 1151. The insulation coating 1153 is configured to electrically insulate two neighboring main surfaces 1151 of different turns or windings of the helical lamination stack 114, 134. In another embodiment, the insulation coating 1153 is arranged at both main surfaces 1151. In an embodiment, the helical lamination stack 114, 134 forms a segment, which is, for example, arranged with other segments on the stator shells 113, 133.

In an embodiment, the helical lamination stack 114, 134 is a multiple geared lamination stack (not shown in FIG. 5). The multiple geared lamination stack is formed out of a plurality of helically wound strips 115, 135 having the same inclination angle or pitch angle. The different strips 115, 135 may have different thicknesses, may comprise different materials and/or may have different insulation coatings.

FIG. 6 shows schematically an electromechanical apparatus 100 according to an embodiment of the present disclosure with cut-away sections to show the interior of the electromechanical apparatus 100. FIG. 6 shows partially an embodiment of the first rotating electromechanical machine 110. FIG. 6 shows the first stator shell 113, the first lamination stack 114 with the first helical wound strip 115, the first coil 116, which comprises the first continuous hairpin winding 117, first magnets 118 arranged on the first rotor shell 121. In addition, the common axis of rotation 122 is shown. The first continuous hairpin winding 117 comprises the first winding layer 1171 and the second winding layer 1172. Within the first rotor shell 121, the second rotating electromechanical machine 130 is arranged (not shown in FIG. 6).

In this embodiment, the helical lamination stack 114 is connected with the first stator shell 113 via a permanent connection. The connection is, for example, formed via a form-fit, press-fit, force-fit or a chemical connection. The helical lamination stack 114 is, for example, press fitted, screwed, shrinked and/or glued into or on the first stator shell 113.

The continuous hairpin winding 117 can have two sets of three phase windings U1, V1, W1, U2, V2, W2, wherein a phase winding U1 of the first set and a corresponding phase winding U2 of the second set have the same electrical phase (and e.g. may be joined together, not shown in FIG. 7). The continuous hairpin winding 117 has input leads, comprising wires, for each of the phase windings U1, V1, W1, U2, V2, W2 in the same region of the electromechanical apparatus 100 such that electrical connection of the continuous hairpin winding 114 is efficient and uncomplicated. In particular, all input leads are within a common, preferably small, azimuthal angular region. An end of each phase winding U1, V1, W1, U2, V2, W2 is electrically joined to at least one other phase winding of the phase windings U1, V1, W1, U2, V2, W2, for example to form a star ground 24 or delta connection. The continuous hairpin winding 114 comprises straight segments extending parallel to the axis 122, bend segments, including an offset bend, and a folded segment.

As can be seen in FIG. 6, the first stator shell 113 forms part of an ironless stator of the rotating electromechanical machine 110. Specifically, the first helical lamination stack 114, the first stator shell 113 and the first hairpin windings 117 is comprised by the first ironless stator 112. The first continuous hairpin winding 117 is covered by the helical lamination stack 114 along its entire axial extension (i.e. its extension parallel to the rotation axis 122). The inner surface of the first helical lamination stack 114 is arranged adjacent to the first continuous hairpin windings 117 and holds the continuous hairpin windings 117 in position. The continuous hairpin windings 117 is entirely arranged within the first stator shell 113 and is thereby protected from mechanical damage, shocks, and contaminations.

The first stator 112 has advantageous small radial extensions and at the same time a high efficiency and is suitable for large industrial or automotive applications.

FIG. 7 shows schematically a cylindrical continuous hairpin winding 117, 137 according to a first exemplary embodiment as used, for example in the first or second rotating electromechanical machine 110, 130. As is shown, all the phase windings U1, V1, W1, U2, V2, W2 have input leads on the same side of the continuous hairpin winding 117, 137 and within the same relatively small azimuthal angular range, which is beneficial for electrically connecting the continuous hairpin winding, for example to a power source and/or a motor controller. Further, the opposite ends of the wires from the input leads are also in the same area, allowing for a star-ground or a delta connection between the phase windings U1, V1, W1, U2, V2, W2 to be easily formed. Each phase winding U1, V1, W1 of the first set and each corresponding phase winding of the second set U2, V2, W2 have the same phase. Such an optimally shaped continuous hairpin winding 117, 137 is required in particular for the electromechanical machine 110, 130 having a very small gap 124 between the continuous hairpin winding 117, 137 and the respective rotor 120, 140. Having a small gap is obviously advantageous for achieving a higher electromagnetic efficiency and in particular for embodiments where the electromechanical apparatus 100.

In an embodiment, the continuous hairpin winding 117, 137 can be potted with a curable potting material. A strong mechanical and thermal bond of the hairpin winding 117, 137 to the lamination stack 114, 134 is advantageous for the reliable transfer of the torque and to the optimal conduct of the heat. It further provides further structural support and increases the electrical insulation between the wires, and improves heat transport away from the wires.

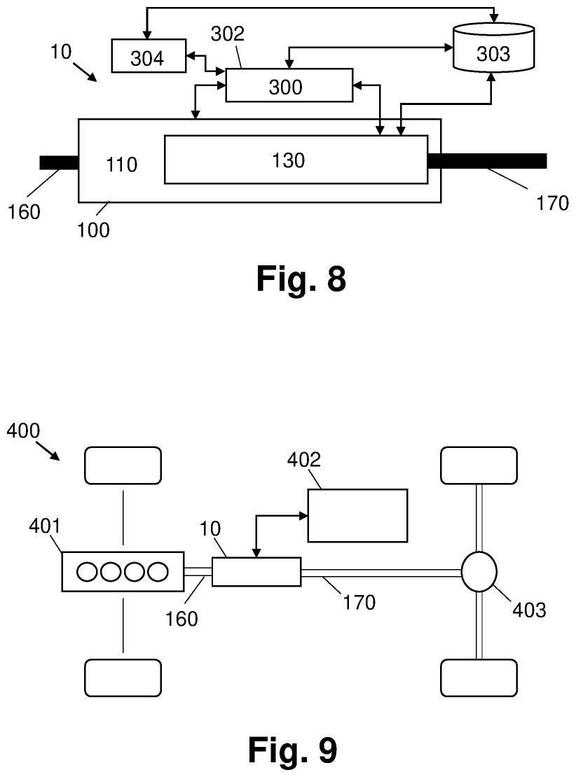

FIG. 8 shows schematically a block diagram of a transmission unit 10 according to an exemplary embodiment. The transmission unit 10 comprises the electromechanical apparatus 100 with the first and second rotating electromechanical machine 110, 130 arranged coaxially and interleaving with respect to each other.

FIG. 8 further shows the input shaft 160 and the output shaft 170. The transmission unit 10 further comprises an electrical component 300 configured to receive electric current, generated during operation of the first or second rotating electromechanical machine 110, 130, and configured to transmit electric current to the other of the first or second rotating electromechanical machine 110, 130, to drive an output shaft 170. The electrical component 300 comprises, according to this embodiment, a converter 302, which is configured to transform the received electric current having first electric properties, in particular a first AC frequency, to the desired electric current having second electric properties, in particular a second AC frequency, for the rotating electromechanical machine 110, 130, configured to drive the output shaft 170 as desired.

The transmission unit 10, according to this embodiment, further comprises a control unit 304 for controlling the properties of the electric current transmitted to the first or second rotating electromechanical machine 110, 130 such that a desired transmission ratio between the first rotor 120 of the first rotating electromechanical machine 110 and the second rotor 140 of the second rotating electromechanical machine 130 is realized. The transmission ratio is, for example, the ratio of the rotational speed of the output shaft 170 to the rotational speed of the input shaft 160. The electrical component 300 is, according to this embodiment, configured to modify the properties of the electric current, which is transmitted to the rotating electromechanical machine 110, 130 working in engine mode, for example, by changing the frequency. The desired transmission ratio is, for example, determined by input parameters received by the control unit 304, and which are transformed by the control unit 304 into control commands for the electrical component 300.

The transmission unit 10 as shown in FIG. 8 further shows a transmission unit battery 303 configured to store and provide electric energy for the transmission unit 10. The transmission unit 10 is configured to transfer mechanical input energy received via the input shaft 160 of the electromechanical apparatus 100 into mechanical output energy transmitted via the output shaft 170 of the electromechanical apparatus 100 to different parts of a vehicle, like a drivetrain of the vehicle. The desired properties of the mechanical output energy can be realized by modifying of the electrical properties of the electric current, which is supplied to the rotating electromechanical machine 110, 130 of the electromechanical apparatus 100 working in engine mode.

The transmission unit battery 303, which is electrically connected with the electromechanical apparatus 100, can be configured such that at least a portion of the electric current, which is produced by the rotating electromechanical machine 110, 130 working in generator mode, is at least temporarily transferred to the transmission unit battery 303. Alternatively or in addition, the transmission unit battery 303 can further be configured such that at least a portion of the electric current, which is needed by the rotating electromechanical machine 110, 130 working in engine mode, is at least temporarily provided by the transmission unit battery 303. According to this embodiment, the transmission unit battery 303 is configured to work as an electric buffer for the transmission unit 10.

FIG. 9 shows schematically a vehicle 400 comprising the transmission unit 10 according to an exemplary embodiment. The vehicle 400 comprises additionally an internal combustion engine 401, a vehicle battery 402 and a drivetrain 403. The internal combustion engine 401 is according to this embodiment mechanically connected to the input shaft 160 of the transmission unit 10 and configured to drive the first or second rotating electromechanical machine 110, 130 working in generator mode. The output shaft 170 of the transmission unit 10 is mechanically connected to the drivetrain 403. The transmission unit 10 replaces for example a conventional gearbox. The transmission unit 10 may be installed in the vehicle 400 as replacement kit. In another embodiment, the transmission unit 10 is installed directly during manufacturing of the vehicle 400.

### LIST OF REFERENCE SIGNS

10 transmission unit
100 electromechanical apparatus
110 first rotating electromechanical machine
112 first stator
113 first stator shell
114 first lamination stack
115 helical wound strip
1151 main surface
1152 side surface
1153 insulation coating
116 first coil
117 first continuous hairpin winding
1171 first winding layer
1172 second winding layer
118 first magnets
120 first rotor
121 first rotor shell
122 common axis of rotation
124 axially extending gap
130 second rotating electromechanical machine
132 second stator
133 second stator shell
134 second lamination stack
135 second helical wound strip
136 second coil
137 second continuous hairpin winding
138 second magnets
140 second rotor
141 second rotor shell
150 support
151 first bearing
152 second bearing
153 third bearing
160 input shaft
170 output shaft
176 interleaving region
180 gear stage
200 first machine thickness
201 second machine thickness
202 overall thickness, radial thickness of electromechanical apparatus
210 cavity, hollow inner machine volume
300 electrical component
302 converter, AC-AC converter
303 transmission unit battery
304 control unit
400 vehicle
401 internal combustion engine
402 vehicle battery
U1, U2, V1, V2, W1, W2 phase windings

1. An electromechanical apparatus for changing motion parameters, the electromechanical apparatus comprising:
a. a first rotating electromechanical machine comprising a first stator and a first rotor, which is arranged to be rotatable with respect to a common axis of rotation,
b. a second rotating electromechanical machine having a smaller radial extension than the first rotating electromechanical machine and comprising a second stator and a second rotor, which is arranged to be rotatable with respect to the common axis of rotation,
wherein the second rotating electromechanical machine is arranged radially within the first rotating electromechanical machine thereby forming an interleaving region of the electromechanical apparatus, wherein the first stator and the second stator are ironless, thereby having no material of high magnetic permeability inside or extending into a region of its coil, and wherein the first rotor is a permanent-magnet rotor or a rotor comprising a winding for electrical excitation, and wherein the second rotor is a permanent-magnet rotor or a rotor comprising a winding for electrical excitation.

2. The electromechanical apparatus according to claim 1, wherein the first rotating electromechanical machine and the second rotating electromechanical machine are designed as an internal rotor electromechanical machine, and wherein an input shaft, which is configured to be coupled to one of the first rotor or the second rotor, is arranged coaxially with respect to an output shaft, which is configured to be coupled to the other of the first rotor or the second rotor.

3. The electromechanical apparatus according to claim 1, wherein the first rotating electromechanical machine is designed as an internal rotor electromechanical machine and the second rotating electromechanical machine is designed as an external rotor electromechanical machine, and wherein an input shaft, which is configured to be coupled to one of the first rotor or the second rotor, is arranged eccentrically with respect to an output shaft, which is configured to be coupled to the other of the first rotor or the second rotor.

4. The electromechanical apparatus according to claim 2, wherein the input shaft is arranged on one axial end of the electromechanical apparatus, and the output shaft is arranged on the other opposing axial end of the electromechanical apparatus.

5. The electromechanical apparatus according to claim 2, wherein the electromechanical apparatus comprises a gear stage arranged between at least one of: the input shaft and the first rotor, the input shaft and the second rotor, the first rotor and the output shaft and the second rotor and the output shaft.

6. The electromechanical apparatus according to claim 1, wherein
a. the first stator and the second stator comprise each a helical lamination stack of a helically wound strip of magnetically permeable material, having multiple turns, wherein the strip comprises two main surfaces and two side surfaces, wherein at least one of the two main surfaces comprises an insulation coating, and/or
b. wherein the first rotor and the second rotor comprise each a helical lamination stack of a helically wound strip of magnetically permeable material, having multiple turns, wherein the strip comprises two main surfaces and two side surfaces, wherein at least one of the two main surfaces comprises an insulation coating.

7. The electromechanical apparatus according to claim 1, wherein
a. the first stator and the second stator comprise each a continuous hairpin winding having at least two winding layers or comprise each a continuous wave winding having at least two winding layers, and
b. wherein the first rotor comprises permanent magnets or a continuous hairpin winding having at least two winding layers or comprises a continuous wave winding having at least two winding layers, and
c. wherein the second rotor comprises permanent magnets or a continuous hairpin winding having at least two winding layers or comprises a continuous wave winding having at least two winding layers.

8. The electromechanical apparatus according to claim 1, wherein the first rotating electromechanical machine has a first machine thickness from its maximum radial outer extension at the interleaving region to its minimum radial inner extension at the interleaving region in a range from 30 mm to 15 mm, preferably from 25 mm to 20 mm, more preferably of 22 mm.

9. The electromechanical apparatus according to claim 1, wherein the second rotating electromechanical machine has a second machine thickness from its maximum radial outer extension at the interleaving region to its minimum radial inner extension at the interleaving region in a range from 30 mm to 15 mm, preferably from 25 mm to 20 mm, more preferably of 22 mm.

10. The electromechanical apparatus according to claim 1, wherein the first rotating electromechanical machine has a maximum radial outer diameter at the interleaving region in a range from 100 mm to 1000 mm, preferably from 150 mm to 350 mm, more preferably of 300 mm.

11. The electromechanical apparatus according to claim 1, wherein a ring-shaped axially extending gap at the interleaving region between the first rotating electromechanical machine and the second electromechanical machine has a thickness of less than 10 mm, preferably of less than 5 mm, more preferably of 3 mm.

12. The electromechanical apparatus according to claim 1, wherein the electromechanical apparatus comprises at its first axial end a first bearing and at its second opposing axial end a second bearing, wherein the first bearing and the second bearing are arranged between two parts selected from a group consisting of: the first stator, the second stator, the first rotor and the second rotor.

13. The electromechanical apparatus according to claim 12, wherein a support of the first rotor (comprises:
a. a first bearing arranged between the first stator and the first rotor on one axial end of the electromechanical apparatus, and
b. a second bearing arranged between the second rotor and the first rotor on the other axial end of the electromechanical apparatus.

14. The electromechanical apparatus according to claim 12, wherein the support of the second rotor comprises:
a. a first bearing arranged between the first stator and the second rotor on one axial end of the electromechanical apparatus, and
b. a second bearing arranged between the second rotor and the first rotor on the other axial end of the electromechanical apparatus.

15. The electromechanical apparatus according to claim 1, wherein the first stator comprises a first stator shell, a first lamination stack and a first coil, and wherein the second stator comprises a second stator shell, a second lamination stack, and a second coil.

16. The electromechanical apparatus according to claim 1, wherein the material of the first stator and/or the second stator inside or extending into a region of its coil has a magnetic permeability of less than 300, preferably of less than 40.

17. A transmission unit for changing motion parameters, the transmission unit comprising:
a. an electromechanical apparatus according to claim 1,
b. an electrical component configured to receive electric current, generated during operation of the first or second rotating electromechanical machine, and configured to transmit electric current to the other of the first or second rotating electromechanical machine, to drive an output shaft, and
c. a transmission unit battery connected to the electrical component and configured to store electrical power received from the electromechanical apparatus and configured to provide electrical power to the electromechanical apparatus, in particular to the rotating electromechanical machine configured to drive the output shaft.

18. The transmission unit according to claim 17, wherein the electrical component comprises a converter, which is configured to transform the received electric current having first electric properties, in particular a first AC frequency, to the desired electric current having second electric properties, in particular a second AC frequency, for the rotating electromechanical machine, configured to drive the output shaft.

19. The transmission unit according to claim 17, wherein the electrical component comprises a control unit for controlling the properties of the electric current transmitted to the first or second rotating electromechanical machine such that a desired transmission ratio, in particular continuously variable transmission ratio, between the first rotor and the second rotor is realized.

20. A vehicle comprising a transmission unit according to claim 17, wherein the vehicle further comprises:
a. an internal combustion engine, which is configured to propel an input shaft of the electromechanical apparatus;
b. a drive train, which is mechanically connected to an output shaft of the electromechanical apparatus and which is configured to propel the vehicle; and
c. a vehicle battery, which is electrically connected to the electrical component and configured to store electrical power received from the electromechanical apparatus and configured to provide electrical power to the vehicle, in particular to the electromechanical apparatus.
